(19) United States
(12) Patent Application Publication
(10) Pub. No.: US 2025/0203495 A1
(43) Pub. Date: Jun. 19, 2025

(54) Avoiding Scan Collisions With Roam Scans

(71) Applicant: ZEBRA TECHNOLOGIES CORPORATION, Lincolnshire, IL (US)

(72) Inventors: Prashanth Venkataramaiah Bagur, Bangalore (IN); Deepak Marian Francis Sams, Bangalore (IN); HariPrasad Mosuru Chandrasekhar, Bangalore (IN)

(21) Appl. No.: 18/545,553

(22) Filed: Dec. 19, 2023

(51) Int. Cl. H04W 48/16; H04W 74/0833; H04W 84/12

(52) U.S. Cl. CPC H04W 48/16; H04W 74/0858; H04W 84/12

(57) ABSTRACT

An example method includes: performing a first scan according to first scan execution parameters; while performing the first scan, receiving a request for a second scan; in response to detecting a conflict between the second scan and the first scan, determining a prioritization parameter for at least one of the first scan and the second scan; updating at least one of the first scan execution parameters and second scan execution parameters based on the prioritization parameter; and proceeding with the first scan according to the first scan execution parameters and proceeding with the second scan according to the second scan execution parameters.

### BACKGROUND

Wireless networks may be serviced by several access points to which mobile devices can connect based on their location within the wireless network. As users of mobile devices move around, the mobile devices may roam to different access points. When connecting to an access point or roaming between access points, the device may perform a scan to identify potential access points by performing channel scans to detect access points operating on a given channel. Other applications may also request different types of scans, which may create competing priorities of the scans to be performed. Prioritization of certain scans over other scans may negatively impact performance of the application requesting the dropped scan.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for dynamically prioritizing scans.

FIG. 2 is a block diagram of certain internal hardware components of certain devices of FIG. 1.

FIG. 3 is a flowchart of an example method of dynamically prioritizing scans.

FIG. 4 is a flowchart of an example method of performing blocks 315 and 320 of the method of FIG. 3.

FIG. 5 is a schematic diagram of dynamically prioritizing scans with different media access control chains.

FIG. 6 is a schematic diagram of dynamically prioritizing scans by offsetting start times of scans with regular scan patterns

FIG. 7 is a schematic diagram of dynamically prioritizing scans with a collision counter.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: performing a first scan according to first scan execution parameters; while performing the first scan, receiving a request for a second scan; in response to detecting a conflict between the second scan and the first scan, determining a prioritization parameter for at least one of the first scan and the second scan; updating at least one of the first scan execution parameters and second scan execution parameters based on the prioritization parameter; and proceeding with the first scan according to the first scan execution parameters and proceeding with the second scan according to the second scan execution parameters.

Additional examples disclosed herein are directed to a device comprising: a communications interface configured to perform scans; a controller for the communications interface, the controller configured to: control the communications interface to perform a first scan according to first scan execution parameters; while performing the first scan, receive a request for a second scan; in response to detecting a conflict between the second scan and the first scan, determine a prioritization parameter for at least one of the first scan and the second scan; update at least one of the first scan execution parameters and second scan execution parameters based on the prioritization parameter; and proceed with the first scan according to the first scan execution parameters and proceeding with the second scan according to the second scan execution parameters.

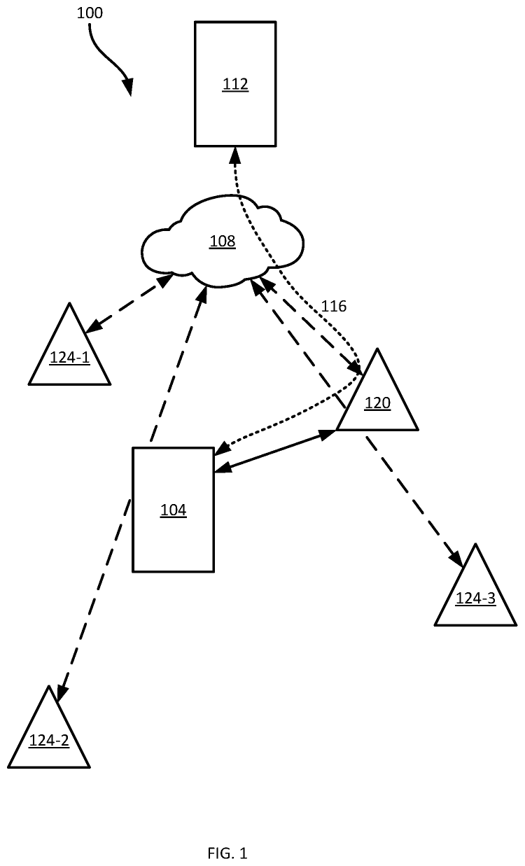

FIG. 1 depicts a system 100 for dynamically prioritizing scans in accordance with the teachings of this disclosure. The system 100 includes a computing device 104 (also referred to herein as simply the device 104) connected to a network 108. The device 104 may communicate with a second computing device 112 (also referred to herein as the peer device 112) via a link 116 which traverses the network 108. In some examples, the device 112 may be remote from the device 104 and the link 116 may therefore additionally traverse one or more wide-area networks such as the Internet, mobile networks and the like.

The device 104 may be a mobile computing device such as a handheld computer, a mobile phone, a tablet, a barcode scanner or the like. As noted above, the device 104 is connected to the network 108, which may be deployed for wireless communications within a facility, such as a transportations and logistics facility, a warehouse, retail establishment, or other facility. Accordingly, the network 108 may be a wireless local area network (WLAN) and/or a wireless wide area network (WWAN) deployed by one or more base stations, including without limitation one or more access points and/or cellular base stations, citizens broadband radio service (CBRS) base stations, or the like. In the present example, four access points, a home access point 120, and three foreign access points 124-1, 124-2, and 124-3 (referred to herein generically as an access point 124 and collectively as access points 124; this nomenclature is also used elsewhere herein) are depicted. In other examples, the network 108 may include more or fewer access points.

In particular, the device 104 may be currently serviced by the home access point 120 to connect to the network 108. Since the device 104 may be mobile, the device 104 may be carried about by a user. As the user of the device 104 moves about the facility or other region serviced by the network 108, the connection of the device 104 to the home access point 120 may weaken, and the device 104 may be better serviced by another foreign access point 124 of the network 108. Accordingly, the device 104 may scan the foreign access points 124 and may subsequently roam to one of the foreign access points 124 to connect to the network 108, for example when the device 104 is out of range of the home access point 120 and/or when a better connection may be achieved via one of the foreign access points 124. To identify the foreign access points 124, the device 104 performs an access point scan (also referred to herein as a roam scan).

In other examples, the device 104 may incur other scan conditions for different types of scans, other than roam scans. For example, an application may request a network scan to identify different networks (i.e., other than the network 108), such as different WLAN networks within range, to which the device 104 may connect. In other examples, an application may request an FTM (fine timing measurement) scan to identify access points 120 or 124 which have FTM capabilities. In still further examples, other types of scans, including other scan triggering conditions are also contemplated. Types of scans other than roam scans may be referred to herein generically as non-roam scans.

In operation, if multiple scans (e.g., a roam scan and a non-roam scan, two non-roam scans, etc.) collide or conflict (i.e., if one scan is requested while another scan is currently ongoing, the scheduled scan periods of the scans overlap and/or the scans cannot be managed simultaneously, or similar), then typically, the device 104 may have a predetermined prioritization of the roam scan or the non-roam scan. For example, the device 104 may be configured to prioritize roam scans, since roam scans may be triggered when signal strength drops below a threshold level, and hence may affect, for example, the quality of WLAN communications. However, in such implementations, the applications requesting non-roam scans may similarly experience a negative performance impact due to a delay in acquiring results from the non-roam scan. Similarly, if the device 104 is configured to prioritize non-roam scans, then WLAN communications may experience a negative performance impact due to the delays in finding new access points to roam to when signal strength drops below a threshold level.

Thus, in accordance with the present disclosure, the device 104 may be configured to dynamically prioritize scans based on respective prioritization parameters associated with the incoming scan (i.e., the scan requested during performance of an ongoing scan) and the ongoing scan. For example, the prioritization parameters may be a collision counter based on the scan type of the incoming scan and a threshold number of collisions for the ongoing scan, respective scan patterns of the incoming scan and the ongoing scan, proposed target MAC chain for the incoming scan and the ongoing scan, and the like.

Based on the prioritization parameters, the device 104 may determine scan execution parameters for each of the incoming scan and the ongoing scan. For example, the execution parameters may include initiation or rejection of the incoming scan, maintenance or termination of the ongoing scan, deferral of a start time of the incoming scan, designation of target MAC chains, and the like. That is, in some examples, one of the incoming scan and the ongoing scan may be prioritized over the other (i.e., while the other is rejected or terminated), while in other examples, the device 104 may be configured to manage both the ongoing scan and the incoming scan, for example by offsetting the ongoing scan and the incoming scan by deferring the start time of the incoming scan, or by designating a different target MAC chain for the incoming scan.

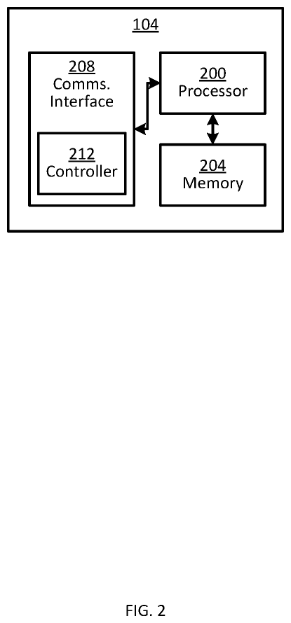

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the device 112. The communications interface 208 is interconnected with the processor 200. The communications interface 208 includes a controller 212, and one or more antennas, transmitters, receivers, or the like (not shown), to allow the device 104 to communicate with other computing devices such as the device 112 over the network 108 via the link 116. In some examples, the communications interface 208 may include a 2×2 or higher capacity radio (i.e., having two or more antennae) to establish two or more streams of data, and in particular, to allow for simultaneous scanning of multiple channels, for example at different frequencies. In particular, each antenna may be identified by separate MAC addresses, and hence the antenna and controlling components allowing scanning capabilities may be referred to herein as a MAC chain. In particular, each MAC chain may include a transmitter and a receiver.

The controller 212 may be a micro-controller, a micro-processor, or other suitable device capable of executing computer-readable instructions to control the components, such as the antennae, transmitters, receivers, and the like, of the communications interface 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein. In particular, the controller 212 may control a dynamic scan prioritization operation of the device 104.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

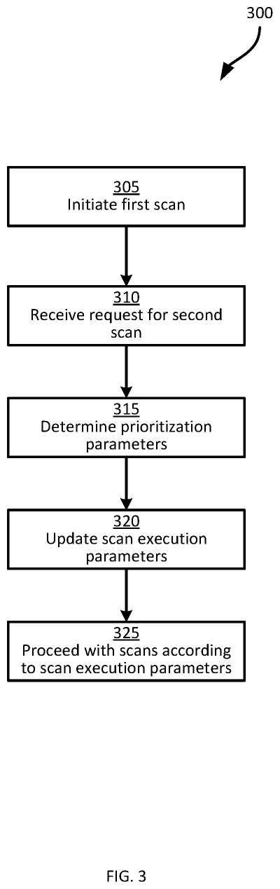

Turning now to FIG. 3, the functionality implemented by the device 104 will be discussed in greater detail. FIG. 3 illustrates a method 300 of dynamically prioritizing scans. The method 300 will be discussed in conjunction with its performance in the system 100, and particularly by the device 104. In particular, the method 300 will be described with reference to the components of FIGS. 1 and 2. In other examples, the method 300 may be performed by other suitable devices or systems.

The method 300 is initiated at block 305, for example in response to the device 104 detecting a scan condition to initiate a first scan. For example, the device 104 may detect that a signal strength to the home access point 120 is below a threshold strength, that a quality of service (e.g., as determined based on jitter, latency, etc.) is below a predetermined threshold, or other similar condition and initiate an access point scan (or roam scan) for foreign access points 124.

At block 310, the device 104 may receive a request for a second scan (i.e., an incoming scan) while the first scan initiated at block 305 is ongoing. For example, the second scan may be a network scan, an FTM scan, or another scan initiated by another application being executed on the device 104. In particular, since the device 104 is actively performing the first scan, the device 104 may detect a collision of the first and second scans. In some examples, a collision may be identified when the request for the second scan overlaps with performance of the first scan, while in other examples, a collision may be identified when performance of the first and second scans conflict with one another. For example, the collision and/or conflict may be identified when the respective scan periods of the first and second scans overlap in time and/or when the scans cannot be handled simultaneously.

At block 315, in response to detecting the collision of the second scan requested at block 310 with the first scan initiated at block 305, the device 104 is configured to determine prioritization parameters for one or both of the first scan and the second scan. The prioritization parameters may be any suitable factors for consideration in determining the respective priorities of the first scan and the second scan. That is, the prioritization parameters allow the device 104 to evaluate a prioritization order and modify the scan execution parameters for each of the first scan and the second scan in accordance with the prioritization order.

For example, the prioritization parameters may be target MAC chains for each of the first and second scans, respective scan patterns for each of the first and second scans, a collision counter for a scan type of the second scan, or the like. In some example, the prioritization parameters for the first scan may include ongoing execution parameters, such as a current MAC chain on which the first scan is executing. Further, the prioritization parameters may be predefined parameters, such as a scan pattern, based on the type of scan, and which may be defined in context of the first and second scans to allow the device 104 to evaluate the priorities of the first and second scans.

At block 320, the device 104 is configured to evaluate the prioritization parameters determined at block 315 to determine how to prioritize the first and second scans. In particular, as the prioritization parameters may be context-specific based on current operating conditions of the device 104 to allow the device 104 to dynamically prioritize the first and second scans, rather than prioritization based on a static rule according to the scan type of the respective scans.

The device 104 may then update the first and second scan execution parameters to reflect the determined prioritization. In some examples, the device 104 may be capable of executing both scans simultaneously, for example on different MAC chains, and accordingly, the first and second scan execution parameters may define the designated MAC chain on which the respective scan is to be executed. In other examples, the device 104 may determine that one scan is to be performed, while the other is dropped. Accordingly, the device 104 may update the scan execution parameters to proceed with the selected scan to be performed (i.e., to maintain the first scan according to the existing first scan execution parameters or to initiate the second scan according to newly defined second scan execution parameters) and to drop the other scan (i.e., to reject the second scan in the second scan execution parameters or to terminate the first scan in first scan execution parameters).

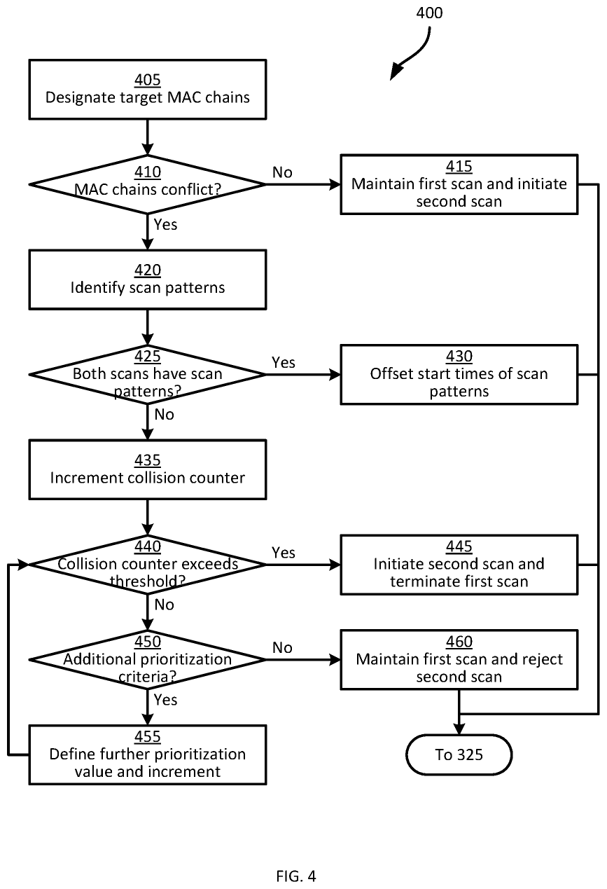

For example, referring to FIG. 4, a flowchart of an example method 400 of determining the prioritization parameters and updating the scan execution parameters at blocks 315 and 320 of the method 300 is depicted. In other examples, a subset of the method 400 may be performed (e.g., evaluating the prioritization parameters individually) and/or otherwise combined in different orders or manners.

At block 405, the device 104 is configured to designate a target MAC chain for each of the first (i.e., ongoing) and second (i.e., incoming) scans. In particular, the first, ongoing scan may be designated the target MAC chain on which the first scan is being performed, while the target MAC chain for the second scan may be a proposed target MAC chain. The designated target MAC chain may represent the prioritization parameter for each scan.

For example, if the device 104 is configured with a 1×1 radio having a single MAC chain, then the device 104 may designate the single MAC chain as the target MAC chain for both the first and second scans. In other examples, if the device 104 is configured with a 2×2 or higher capacity radio having multiple MAC chains, then the device 104 may designate the target MAC chain based on features of the first and second scans themselves. For example, each of the MAC chains may be assigned to handle different types of scans, such as roam scans versus non-roam scans. Accordingly, the target MAC chain may be designated based on the respective types of each of the first and second scans. In other examples, the target MAC chain may be designated based on the frequency of the channels to be scanned, other suitable features, or simply by selecting a MAC chain which is currently available for use (i.e., not being used to perform scans or otherwise transmit or receive for the device 104).

At block 410, the device 104 is configured to evaluate the designated target MAC chain for the first and second scans to determine whether the designated target MAC chains conflict. That is, the device 104 determines whether the designated target MAC chains can handle the respective scans. For example, if the designated target MAC chain for the first scan is different from the designated target MAC chain for the second scan, then the device 104 may make a negative determination at block 410. That is, the first and second scans may each be performed by different MAC chains (i.e., including different antennae and controlling components) configured for simultaneous scan operations.

If the designated target MAC chain for the first scan is the same as the designated target MAC chain for the second scan, then the device 104 may determine whether the type of the first and second scans allows the same MAC chain to handle both scans. For example, if the first and second scans are non-roam scans, then in some examples, the scans may be queued or time-sliced within the same MAC chain. Accordingly, in such examples, the device 104 may also make a negative determination at block 410.

If the designated target MAC chain for the first scan is the same as the designated target MAC chain for the second scan and the designated target MAC chain cannot manage both scans simultaneously (e.g., a roam scan and a non-roam scan), then the device 104 may make an affirmative determination at block 410.

If the determination at block 410 is negative, that is, the MAC chains do not conflict, then the device 104 proceeds to block 415. At block 415, having determined that the designated target MAC chains are capable of processing or handling both the first and second scans, the device 104 may maintain the first scan execution parameters to continue executing on the designated target MAC chain of the first scan. The device 104 may additionally define second scan execution parameters to initiate (or queue, as appropriate) the second scan on the designated target MAC chain of the second scan. That is, the device 104 may authorize performance of each of the first and second scans (i.e., via the first and second scan execution parameters, respectively). The device 104 may then return to block 325 of the method 300 to proceed with the first and second scans according to the first and second scan execution parameters, respectively.

In some examples, may apply additional prioritization analysis, for example based on parameters such as a timestamp of most recent scan results, RSSI changes, device motion changes, and the like, to apply a priority order to scans within the queue. The device 104 may apply the priority order as scan execution parameters for each scan in the queue.

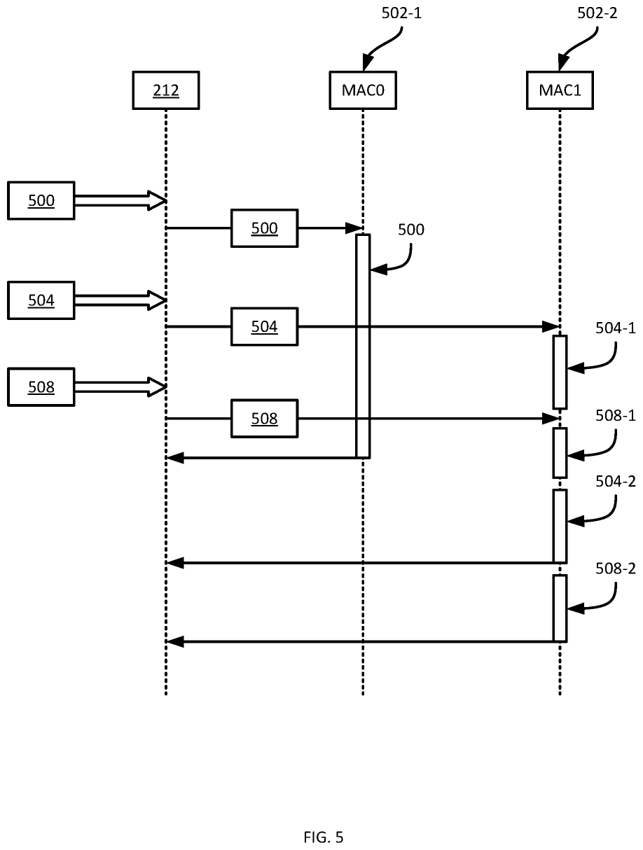

For example, referring to FIG. 5, a schematic diagram of an example flow of scan requests and designation to target MAC chains is depicted. For example, a request for a first scan 500 may be received at the controller 212. The first scan 500 may be a roam scan, for example, and hence the controller 212 may designate a first MAC chain 502-1 (“MAC0”) to execute the first scan 500.

While the first scan 500 is being performed, the controller 212 may receive a request for a second scan 504. The second scan 504 may be, for example, a non-roam scan. Upon receiving the request for the second scan 504, the controller 212 may designate a second MAC chain 502-2 (“MAC1”) as the target MAC chain for the second scan 504. For example, the designation of the MAC chain 502-2 may be based on availability of the MAC chain 502-2 or based on the second scan 504 being a non-roam-type scan. Accordingly, since the target MAC chains 502-1 and 502-2 do not conflict, the controller 212 may define the second scan execution parameters for the second scan 504 to initiate the second scan 504 on the second MAC chain 502-2.

While the first and second scans 500 and 504 are being performed, the controller 212 may receive a request for a third scan 508. The third scan 508 may be, for example, another non-roam scan. Upon receiving the request for the third scan 508, the controller may designate the second MAC chain 502-2 as the target MAC chain for the third scan 508. For example, the designation of the MAC chain 502-2 may be based on the third scan 508 being a non-roam-type scan or a capacity of the MAC chain 502-2 to time-slice the second scan 504 and the third scan 508. Accordingly, since the target MAC chain 502-2 for the third scan 508 does not conflict with either the target MAC chain 502-1 for the first scan 500 or the target MAC chain 502-2 for the second scan 504, the controller 212 may define the third scan execution parameters for the third scan 508 to initiate the third scan 508 on the second MAC chain 502-2. Further, the controller may update the second scan execution parameters to pause execution after a first portion 504-1, and to resume a second portion 504-2 of the second scan 504 after a first portion 508-1 of the third scan 508 is executed. A second portion 508-2 of the third scan 508 may be resumed after completion of the second portion 504-2 of the second scan 504 is completed. In other examples, the second scan 504 and the third scan 508 may be further portioned or otherwise ordered according to scan requirements, priority order between the second scan 504 and the third scan 508, and the like.

In other examples, if the second MAC chain 502-2 is not capable of time-slicing the second scan 504 and the third scan 508, the third scan 508 may be rejected.

Returning to FIG. 4, if the determination at block 410 is affirmative, that is, the device 104 determines that the designated target MAC chains conflict and are unable to manage the first and second scans, then the device 104 may proceed to block 420. In some examples, if the device 104 is configured with only one MAC chain, then the device 104 may skip blocks 405 to 415 and proceed directly to block 420 upon initiation of the method 400.

At block 420, the device 104 identifies a respective scan pattern for each of the first and second scans. In particular, the scan pattern represents a recurrence of the scan request for each respective type of scan. The scan pattern may represent another prioritization parameter for each scan. In some examples, the scan pattern for the given type of scan may be known (e.g., previously determined, or predefined), and hence the device 104 may simply retrieve the scan pattern from memory. In other examples, the device 104 may determine the scan pattern based on historical occurrences within a predetermined time frame of scan requests of the given type.

For example, if the second scan is a network scan, then the device 104 may identify requests for network scans received in the predetermined time frame (e.g., 1 minute, 5 minutes, etc.). The device 104 may identify the time intervals between subsequent network scans. If the time intervals or a subset of the time intervals, and in particular, subsequent time intervals, are consistent with one another (e.g., within a threshold percentage), then the device 104 may identify the interval and a time at which at least one of the requests was received as forming the scan pattern. In some examples, the device 104 may determine the scan pattern when at least a threshold number of historical requests have been made and/or when at least a threshold number of historical requests demonstrate a predictable time interval therebetween.

If the time interval between subsequent scans of the given type varies (e.g., by above the threshold percentage), then the device 104 may identify the scan pattern as not existing or being irregular

At block 425, the device 104 is configured to determine whether both first and second scans have regular (i.e., having at least one repeating, recurring, or predictable feature, such as a predictable start or origin time, a regular, repeating interval, or the like) scan patterns.

If the determination at block 425 is affirmative, then the device 104 proceeds to block 430. At block 430, the device 104 is configured to adjust the scan execution parameters of one or both of the first and second scans to offset the time at which the first and second scans are initiated (i.e., the respective start times), in accordance with the scan patterns identified. For example, since the first scan is ongoing, the device 104 may adjust the second scan execution parameters to begin at a midpoint of the interval between subsequent start times of the first scan (i.e., based on the first scan pattern). In other examples, the second scan may begin at a different percentage span of the interval between subsequent start times of the first scan, or may be adjusted by a fixed amount (e.g., 3 seconds). In still further examples, the first scan execution parameters may additionally or alternately be modified to offset the time at which the first and second scans are initiated. The device 104 may then return to block 325 of the method 300 to proceed with the first and second scans according to the first and second scan execution parameters, respectively.

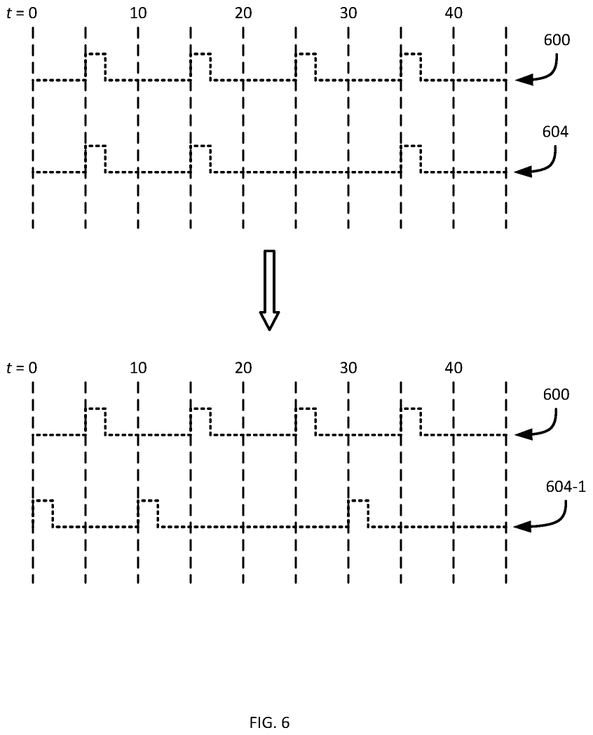

For example, referring to FIG. 6, the device 104 may identify a first scan pattern 600 for a first scan. In particular, the first scan pattern 600 may include an interval of 10 seconds, with a start or origin time of 5 seconds. The device 104 may further identify a second scan pattern 604 for a second scan. In particular, the second scan pattern 604 may have a start or origin time of 5 seconds, and an interval of 10 seconds, but may not recur at every interval. Accordingly, the device 104 may update the scan execution parameters to redefine a second scan pattern 604-1 to have a start or origin time of 0 seconds, so that the scan patterns 600 and 604 do not conflict.

Returning to FIG. 4, if the determination at block 425 is negative, that is, the device 104 determines that one or both of the first scan and the second scan do not have distinguishable scan patterns, then the device 104 proceeds to block 435. That is, if one of the scans does not recur on a predictable schedule, then adjusting the start time of one or both of the scan requests may not adequately increase the likelihood that subsequent scan requests will be offset from one another.

At block 435, the device 104 is configured to increment a collision counter for the scan type of the second scan. In particular, the collision counter may represent another prioritization parameter for the second scan.

At block 440, the device 104 is configured to compare the collision counter to a threshold collision value. The threshold collision value may be a predefined value, and may vary, for example based on the type of the first scan. Accordingly, the threshold collision value may represent another prioritization parameter for the first scan.

If, at block 440, the device 104 determines that the collision counter for the second scan type exceeds the threshold collision value for the first scan type, then the device 104 proceeds to block 445. At block 445, the device 104 determines that the number of collisions experienced by the second scan type warrants prioritization of the second scan, to reduce the likelihood that the requesting application will experience a negative performance impact. Accordingly, the device 104 may define the second scan execution parameters to initiate the second scan. Further, the device 104 may update the first scan execution parameters to terminate the first scan. The device 104 may additionally reset the collision counter for the second scan type to a default value (e.g., zero). The device 104 may then return to block 325 of the method 300 to proceed with the first and second scans according to the first and second scan execution parameters, respectively.

If, at block 440, the device 104 determines that the collision counter for the second scan type does not exceed the threshold collision value for the first scan type, then the device 104 proceeds to block 450. At block 450, the device 104 determines whether the second scan meets additional prioritization criteria. The additional prioritization criteria may be evaluated based on features of the first and second scans and the scan types, as well as other factors, including but not limited to: the received signal strength indicator (RSSI) of the device 104, motion data for the device 104, roam scan results, application and/or service status (e.g., whether the application is in the foreground or background of focus), timestamp of scan results, combinations of the above, and the like. The additional prioritization criteria may further specify that a further prioritization value has not yet been assigned to the instance of the second scan (i.e., that the second scan is a new scan being processed).

If, at block 450, the device 104 determines that the second scan meets the additional prioritization criteria, then the device 104 proceeds to block 455. At block 455, the device 104 defines a further prioritization value and further increments the collision counter by the further prioritization value. The device 104 may then return to block 440 to compare the updated collision counter to the threshold collision value.

For example, if the change in RSSI of the device 104 and the motion data for the device 104 over a predefined time interval are below respective threshold values, then the device 104 may assume that the device 104 is being maintained in a substantially stable and stationary position. Accordingly, even if the RSSI to the home access point 120 is below the threshold strength, the device 104 may expect that the same roam scan results may be obtained as a previous roam scan performed within the predefined time interval. Accordingly, if the previous roam scan yielded results resulting in maintaining the connection to the home access point, then roam scans may be designated as low priority. Accordingly, if the ongoing scan is a roam scan, and the incoming scan is a non-roam scan, then the device 104 may determine that the incoming scan meets the additional prioritization criteria. Further, the device 104 may define a further prioritization value equal to that of the threshold collision value. This may have the effect of prioritizing the incoming non-roam scans over roam scans, provided that the RSSI and motion data remain substantially stable.

In contrast, if the change in RSSI and/or motion data of the device 104 over the predefined time interval is above the respective thresholds, the device 104 may be determined to be in motion and that a new roam scan may yield different results than the previous roam scan. Accordingly, the incoming non-roam scan may not meet the additional prioritization criteria. Notably, the collision counter for the incoming non-roam scan is still incremented at block 435, and accordingly, when the threshold number of collisions have occurred (i.e., equal to the threshold collision value), the incoming non-roam scan may still be determined to have priority to balance the execution of roam scans and non-roam scans.

In still further examples, for example based on different types of non-roam scans, roam scans and non-roam scans may be equally weighted. Accordingly, the device 104 may determine that the incoming non-roam scan meets the additional prioritization criteria, and may define a further prioritization value equal to half (e.g., rounded down) that of the threshold collision value. This may have the effect of causing alternating prioritization of the roam scan and the non-roam scan.

In other examples, the additional prioritization criteria may be evaluated prior to comparing the collision counter to the threshold collision value at block 440 to further increment the collision counter prior to performing the comparison. This may reduce the number of comparisons evaluated by the device 104.

If, at block 450, the device 104 determines that the second scan does not meet the additional prioritization criteria, then the device 104 proceeds to block 460. At block 460, the device 104 determines that the first scan is to be prioritized over the second scan. Accordingly, the device 104 may define the second scan execution parameters to reject the second scan. The device 104 may maintain the first scan execution parameters to allow the first scan to continue executing. The device 104 may then return to block 325 of the method 300 to proceed with the first and second scans according to the first and second scan execution parameters, respectively.

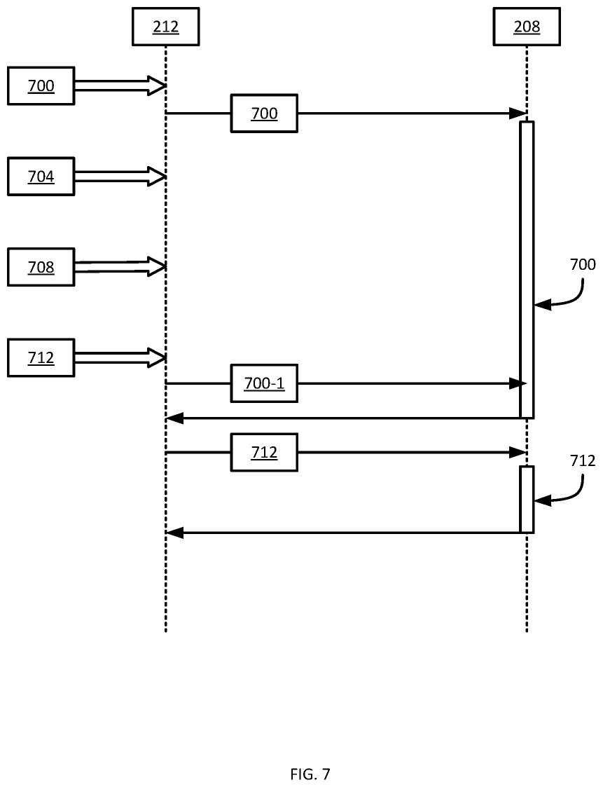

For example, referring to FIG. 7, a schematic diagram of an example flow of scan requests is depicted. For example, a request for a first scan 700 may be received at the controller 212. The first scan 700 may be a roam scan, for example, and the controller 212 may initiate the first scan 700 at the communications interface 208.

While the first scan 700 is being performed, the controller 212 may receive a request for a second scan 704. The second scan may be, for example, a non-roam scan. Upon receiving the request for the second scan 704, the controller 212 may increment the collision counter for the scan type of the second scan 704 (e.g., to 1), and may compare the collision counter to the a threshold collision value associated, for example, with roam scans (e.g., 3). Since the collision counter does not equal or exceed the threshold collision value, the controller 212 may reject the second scan 704 and update the second scan execution parameters to reflect the rejection of the second scan 704.

Similarly, the controller 212 may increment the collision counter to 2 when a third scan 708 (having the same scan type as the second scan 704) is received and may similarly reject the third scan 708.

When the controller 212 receives a fourth scan 712 having the same scan type as the second scan 704, the controller 212 may increment the collision counter to 3. Accordingly, the controller 212 may determine that the collision counter equals or exceeds the threshold collision value, and hence the controller 212 may update the first scan execution parameters with a termination instruction 700-1. The controller 212 may additionally update fourth scan execution parameters to initiate the fourth scan 712 at the communications interface 208. The collision counter for the scan type may then be reset.

In other examples, if the second scan 704 or the third scan 708 meet additional prioritization criteria, the controller 212 may define a further prioritization value and increment the collision counter by the further prioritization value, which may result in the collision counter equaling or exceeding the threshold collision value of the first scan 700 prior to the fourth scan 712.

Returning to FIG. 3, at block 325, the device 104 proceeds with the first scan according to the first scan execution parameters and proceeds with the second scan according to the second scan execution parameters.

In other examples, more or fewer prioritization parameters, including different prioritization parameters, different subsets or combinations of prioritization parameters, other than the target MAC chain, the scan pattern and the collision pattern, and the like, may be applied to dynamically determine prioritization of colliding scans.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
performing a first scan according to first scan execution parameters;
while performing the first scan, receiving a request for a second scan;
in response to detecting a conflict between the second scan and the first scan, determining a prioritization parameter for at least one of the first scan and the second scan;
updating at least one of the first scan execution parameters and second scan execution parameters based on the prioritization parameter; and
proceeding with the first scan according to the first scan execution parameters and proceeding with the second scan according to the second scan execution parameters.

2. The method of claim 1, wherein the prioritization parameter comprises respective target media access control (MAC) chains for the first scan and the second scan.

3. The method of claim 2, further comprising:
determining whether the respective target MAC chains for the first scan and the second scan conflict; and
when the respective target MAC chains do not conflict, maintaining the first scan execution parameters and defining the second scan execution parameters to initiate the second scan.

4. The method of claim 1, wherein the prioritization parameter comprises respective scan patterns for the first scan and the second scan.

5. The method of claim 4, further comprising: when both the first scan and the second scan have regular scan patterns, offsetting respective start times of the first scan and the second scan.

6. The method of claim 1, wherein the prioritization parameter comprises a collision counter for a scan type of the second scan.

7. The method of claim 6, further comprising:
incrementing the collision counter;
comparing the collision counter to a threshold collision value for the first scan; and
when the collision counter exceeds the threshold collision value, updating the first scan execution parameters to terminate the first scan and defining the second scan execution parameters to initiate the second scan.

8. The method of claim 7, further comprising:
when additional prioritization criteria are detected, defining a further prioritization value; and
further incrementing the collision counter to the threshold collision value prior to comparing the collision counter to the threshold collision value.

9. The method of claim 7, further comprising:
when the collision counter does not exceed the threshold collision value, maintaining the first scan execution parameters and defining the second scan execution parameters to reject the second scan.

10. A computing device comprising:
a communications interface configured to perform scans;
a controller for the communications interface, the controller configured to:
control the communications interface to perform a first scan according to first scan execution parameters;
while performing the first scan, receive a request for a second scan;
in response to detecting a conflict between the second scan and the first scan, determine a prioritization parameter for at least one of the first scan and the second scan;
update at least one of the first scan execution parameters and second scan execution parameters based on the prioritization parameter; and
proceed with the first scan according to the first scan execution parameters and proceeding with the second scan according to the second scan execution parameters.

11. The computing device of claim 10, wherein the prioritization parameter comprises respective target media access control (MAC) chains for the first scan and the second scan.

12. The computing device of claim 11, wherein the controller is further configured to:
determine whether the respective target MAC chains for the first scan and the second scan conflict; and
when the respective target MAC chains do not conflict, maintain the first scan execution parameters and define the second scan execution parameters to initiate the second scan.

13. The computing device of claim 10, wherein the prioritization parameter comprises respective scan patterns for the first scan and the second scan.

14. The computing device of claim 13, wherein the controller is further configured to:
when both the first scan and the second scan have regular scan patterns, offset respective start times of the first scan and the second scan.

15. The computing device of claim 10, wherein the prioritization parameter comprises a collision counter for a scan type of the second scan.

16. The computing device of claim 15, wherein the controller is further configured to:
increment the collision counter;
compare the collision counter to a threshold collision value for the first scan; and
when the collision counter exceeds the threshold collision value, update the first scan execution parameters to terminate the first scan and defining the second scan execution parameters to initiate the second scan.

17. The computing device of claim 16, wherein the controller is further configured to:
when additional prioritization criteria are detected, define a further prioritization value; and
further increment the collision counter to the threshold collision value prior to comparing the collision counter to the threshold collision value.

18. The computing device of claim 16, wherein the controller is further configured to:
when the collision counter does not exceed the threshold collision value, maintain the first scan execution parameters and define the second scan execution parameters to reject the second scan.
